(19) United States
(12) Patent Application Publication
(10) Pub. No.: US 2022/0253693 A1
(43) Pub. Date: Aug. 11, 2022

(54) COMPUTER-READABLE RECORDING MEDIUM STORING MACHINE LEARNING PROGRAM, APPARATUS, AND METHOD

(71) Applicant: FUJITSU LIMITED, Kawasaki-shi (JP)

(72) Inventor: Yasushi Hara, Kunitachi (JP)

(73) Assignee: FUJITSU LIMITED, Kawasaki-shi (JP)

(21) Appl. No.: 17/509,104

(22) Filed: Oct. 25, 2021

(30) Foreign Application Priority Data
Feb. 5, 2021 (JP) 2021-017689

(51) Int. Cl. G06N 3/08; G06K 9/62

(52) U.S. Cl. CPC G06N 3/08; G06K 9/6265

(57) ABSTRACT

A recording medium stores a machine learning program for causing a computer to execute processing including: acquiring, in deep learning of a model that includes layers, information that indicates a learning status for each iterative processing of learning processing; determining progress of learning based on the information that indicates the learning status; skipping a part of learning processing of each layer included in a first layer group from a input layer to a specific layer and in which the progress of the learning satisfies a condition; and restarting the part of the learning processing skipped when the part of the learning processing is skipped and a change amount of an evaluation value, which is based on the information that indicates the learning status, of any of layers included in a second layer group from a next layer of the specific layer to an output layer exceeds a threshold range.

### CROSS-REFERENCE TO RELATED APPLICATION

This application is based upon and claims the benefit of priority of the prior Japanese Patent Application No. 2021-17689, filed on Feb. 5, 2021, the entire contents of which are incorporated herein by reference.

### FIELD

The embodiment discussed herein is related to a machine learning program, a machine learning apparatus, and a machine learning method.

### BACKGROUND

Various types of recognition processing such as image recognition, voice recognition, and natural language processing are performed by using a model such as a multi-layer neural network machine-learned by deep learning. As the number of layers of a neural network increases, recognition accuracy of a model improves, and the model tends to become larger in scale. In a large-scale model, calculation time for recognition processing and the like increases. Furthermore, in the large-scale model, parameters to be optimized are enormous, so that calculation time for machine learning also increases. A technology related to reduction of such calculation time has been proposed.

Japanese Laid-open Patent Publication No. 2019-70950 and U.S. Patent Application Publication No. 2019/0188538 are disclosed as related art.

### SUMMARY

According to an aspect of the embodiments, a non-transitory computer-readable recording medium stores a machine learning program for causing a computer to execute processing including: acquiring, in deep learning of a model that includes a plurality of layers that includes an input layer and an output layer, information that indicates a learning status for each iterative processing of learning processing; determining progress of learning of each layer on the basis of the information that indicates the learning status; skipping a part of learning processing of each layer which is included in a first layer group from the input layer to a specific layer and in which the progress of the learning satisfies a predetermined condition; and restarting the part of the learning processing skipped in each layer included in the first layer group in a case where the part of the learning processing of each layer included in the first layer group is skipped and a change amount of an evaluation value, which is based on the information that indicates the learning status, of any of layers included in a second layer group from a next layer of the specific layer, which is close to a side of the output layer, to the output layer exceeds a predetermined threshold range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a machine learning apparatus;

FIG. 2 is a schematic diagram illustrating an example of a model;

FIG. 3 is a diagram for describing learning processing;

FIG. 4 is a diagram illustrating an example of an evaluation value database (DB);

FIG. 5 is a diagram for describing skipping of the learning processing according to progress of learning;

FIG. 6 is a diagram for describing skipping of the learning processing;

FIG. 7 is a schematic diagram illustrating an evaluation value for each epoch in a predetermined layer in a case where the learning processing is not skipped and in a case where the learning processing is skipped;

FIG. 8 is a diagram for describing calculation of a change amount of the evaluation value;

FIG. 9 is a diagram for describing a threshold range to be compared with the change amount of the evaluation value;

FIG. 10 is a diagram for describing the threshold range to be compared with the change amount of the evaluation value;

FIG. 11 is a diagram for describing another method of determining whether or not the change amount of the evaluation value exceeds the threshold range;

FIG. 12 is a block diagram illustrating a schematic configuration of a computer that functions as the machine learning apparatus;

FIG. 13 is a flowchart illustrating an example of the learning processing;

FIG. 14 is a flowchart illustrating an example of skip setting processing;

FIG. 15 is a flowchart illustrating an example of restart setting processing;

FIG. 16 is a diagram for describing an outline of the restart setting processing;

FIG. 17 is a diagram illustrating an example of an error gradient for this method;

FIG. 18 is a diagram illustrating an example of a comparison result of accuracy evaluations between this method and comparison methods of no skipping and no restarting; and

FIG. 19 is a block diagram illustrating another example of a hardware configuration of the machine learning apparatus.

### DESCRIPTION OF EMBODIMENTS

For example, an information estimation apparatus has been proposed that calculates a variance value representing uncertainty of an estimation result at high speed without performing calculation processing an enormous number of times in the estimation apparatus using a neural network. This apparatus relates to a neural network having an integrated layer including a combination of a dropout layer for dropping out a part of input data and a fully connected (FC) layer or convolution layer for calculating a weight. Furthermore, this neural network has an activation layer for performing calculation using a non-linear function at least before or after the integrated layer. In this neural network, this apparatus refers to data related to a multivariate distribution input to the activation layer, and determines whether or not a variance value of the multivariate distribution output from the activation layer through calculation in the activation layer may be set to zero. Furthermore, when performing calculation in the integrated layer, this apparatus skips calculation related to the multivariate distribution determined by a data analysis unit that the variance value may be set to zero.

Furthermore, for example, a machine learning method has been proposed for using one or more skip areas to label, train, and/or evaluate a machine learning model. This method includes using one or more skip areas to label, train, and/or evaluate a machine learning model and specifying the one or more skip areas with respect to an image. Here, a non-skip area of the image is a portion of the image that is not in the one or more skip areas. This method further includes, by a processor, initiating a labeling of one or more features in the non-skip area of the image while excluding the one or more skip areas from the labeling to create a partially labeled image. Here, the partially labeled image is included in a training dataset for training a machine learning model.

In a case where a part of processing is skipped to reduce calculation time for machine learning of a model, prediction accuracy of the model reached at the end of the machine learning may deteriorate, or learning time may be increased to obtain desired prediction accuracy.

As one aspect, the disclosed technology aims to avoid inappropriate skipping of learning processing that results in a deterioration in prediction accuracy and an increase in learning time.

Hereinafter, an example of an embodiment according to the disclosed technology will be described with reference to the drawings.

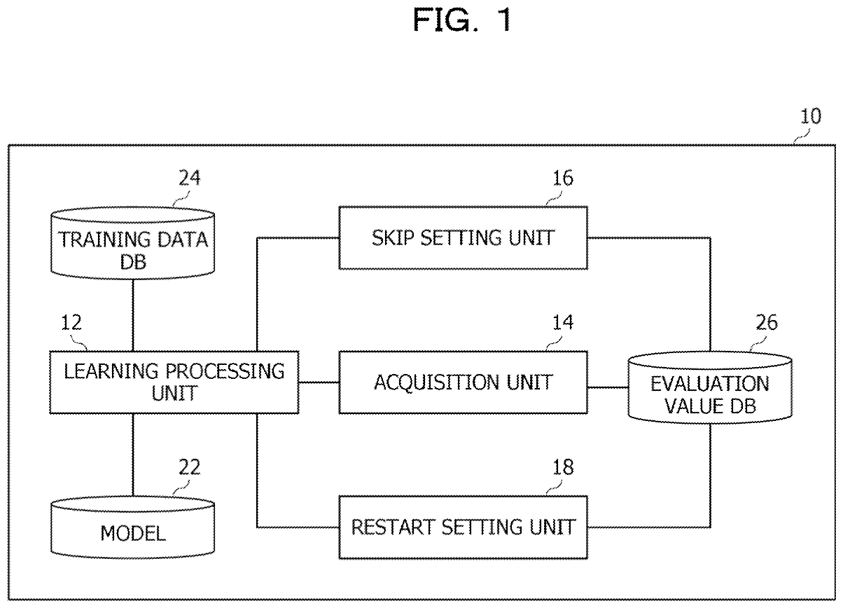

As illustrated in FIG. 1, a machine learning apparatus 10 functionally includes a learning processing unit 12, an acquisition unit 14, a skip setting unit 16, and a restart setting unit 18. Furthermore, in a predetermined storage area of the machine learning apparatus 10, a model 22, a training data database (DB) 24, and an evaluation value DB 26 are stored.

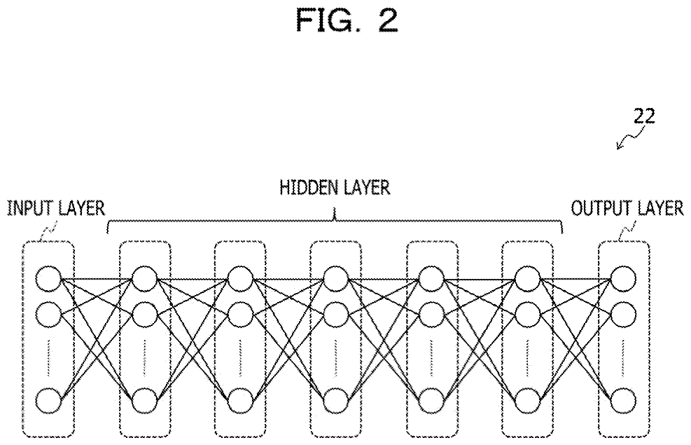

The model 22 is a model as an object of machine learning, here a neural network including an input layer, a hidden layer, and an output layer, as schematically illustrated in FIG. 2. Each layer of the model 22 includes one or more neurons (circles in FIG. 2). The neurons in the hidden layer and the output layer have activation functions inside. Furthermore, a weight indicating strength of connection is set between neurons connected between layers.

The training data DB 24 stores a plurality of pieces of training data used for machine learning of the model 22. The training data is data input to the model 22, and is data to which a label indicating a correct answer of an output value of the model 22 for the training data is given.

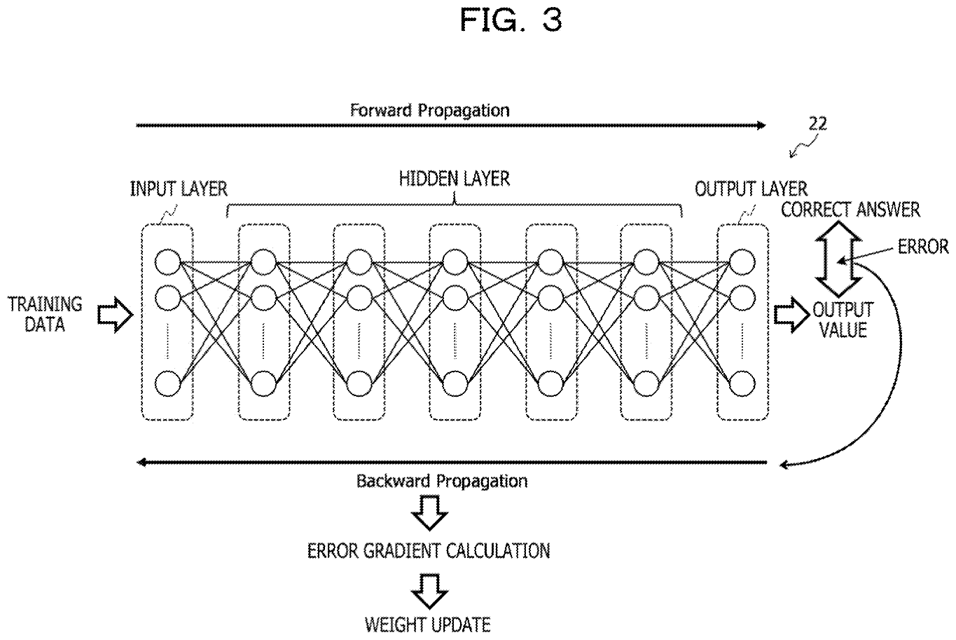

The learning processing unit 12 executes machine learning of the model 22 by using training data, and optimizes a weight included in the model 22. The learning processing unit 12 executes learning processing including first processing, second processing, and third processing. For example, as illustrated in FIG. 3, the learning processing unit 12 executes, as the first processing, processing of calculating an error between an output value output from the output layer by inputting the training data from the input layer and a correct answer indicated by a label given to the training data (“Forward Propagation” in FIG. 3). For example, a value obtained by multiplying a value of the training data input to each neuron in the input layer by a weight between a neuron in the next layer is input to the neuron in the next layer. From the neuron in the next layer, a value obtained by applying an activation function to the input value is output and becomes an input to a neuron in the next layer. In this way, the value is forward-propagated, and finally an output value is output from each neuron in the output layer. The learning processing unit 12 calculates, for example, a sum of squared error between this output value and the value indicated by the label as an error.

Furthermore, the learning processing unit 12 executes, as the second processing, processing of backward-propagating information regarding the error calculated in the first processing from the output layer to the input layer and calculating an error gradient for each weight (“Backward Propagation” and “Error Gradient Calculation” in FIG. 3). The error gradient is an estimated value of a change amount of the error in a case where the weight is updated by a unit amount. Furthermore, the learning processing unit 12 executes, as the third processing, processing of updating the weight between the layers by using the error gradient calculated in the second processing (“update weight” in FIG. 3).

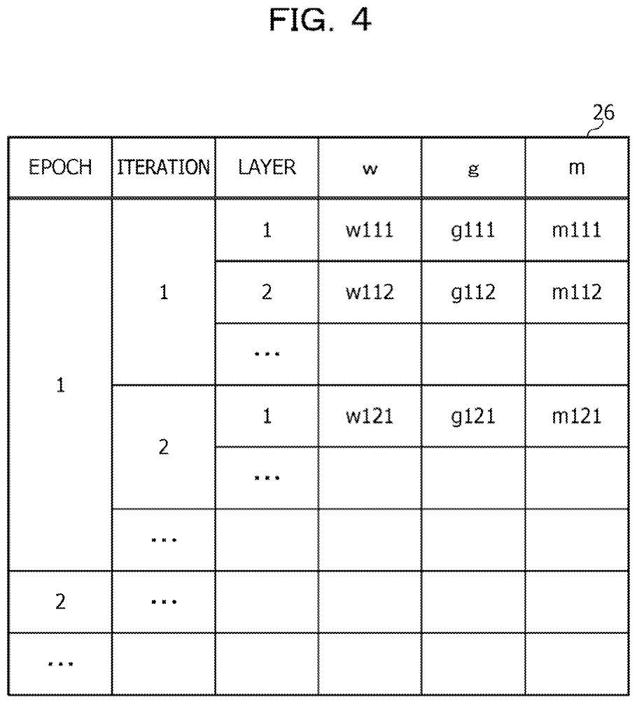

The acquisition unit 14 acquires information indicating a learning status for each iterative processing of learning processing by the learning processing unit 12. For example, the acquisition unit 14 acquires a weight, error gradient, and momentum obtained in the process of the learning processing by the learning processing unit 12 for every one iteration, which is the minimum unit of the iterative processing of the learning processing, and stores the acquired weight, error gradient, and momentum in the evaluation value DB 26. The momentum is a coefficient used in a gradient descent method using a momentum method, and is a moving average of the error gradient. FIG. 4 illustrates an example of the evaluation value DB 26. In the example of FIG. 4, “w” is a weight, “g” is an error gradient, and “m” is a momentum. Furthermore, “layer” is information for identifying which layers the weight is between, and here, 1 is set between the input layer and the next layer, and 2, 3, . . . are set between the following layers.

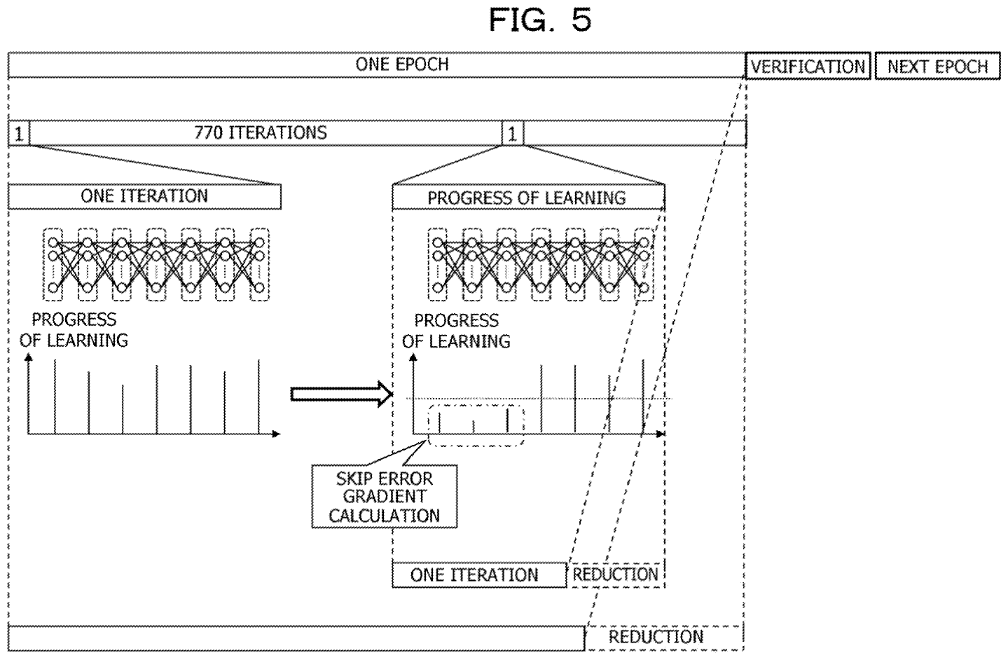

Here, by repeatedly executing the learning processing, weight optimization, for example, learning progresses. Progress of the learning may be represented by, for example, a difference in weight between iterations and magnitude of the error gradient. In this case, it is represented that the smaller the difference in weight and the error gradient, the more progressed the learning. As illustrated in FIG. 5, in an initial stage of the learning processing, learning of the weight of each layer has not yet progressed. As the number of iterations of the learning processing increases, the learning progresses. In addition, as in layers indicated by an alternate long and short dash line in FIG. 5, in some layers, the difference in weight and the error gradient are small, and further learning may not be needed.

Thus, the skip setting unit 16 determines progress of learning of each layer on the basis of information stored in the evaluation value DB 26, and performs setting to skip a part of the learning processing of each layer which is included in a first layer group from the input layer to a specific layer and in which the progress of the learning satisfies a predetermined condition. Here, a case will be described where the difference in weight between iterations is used as the progress of the learning. For example, the skip setting unit 16 acquires a weight in a current iteration and a weight in a preceding iteration from the evaluation value DB 26, and calculates a difference between these weights. The skip setting unit 16 determines a layer closest to a side of the output layer as a specific layer, among layers that are continuous in order from the input layer, in each of which the calculated difference in weight is equal to or smaller than a predetermined threshold. Then, for example, by setting a flag indicating that a part of the learning processing is skipped in each layer included in the first layer group from the input layer to the specific layer, the skip setting unit 16 performs setting to skip a part of the learning processing for each layer included in the first layer group.

For the layers in which skipping is set, the second processing is skipped in the learning processing by the learning processing unit 12. Since the error gradient of each layer is not calculated by skipping the second processing, the third processing is also skipped. For example, for each layer included in the first layer group, only the first processing of the learning processing is executed, and for each layer included in a second layer group from the next layer of the specific layer, which is close to the side of the output layer, to the output layer, the first processing, the second processing, and the third processing are executed.

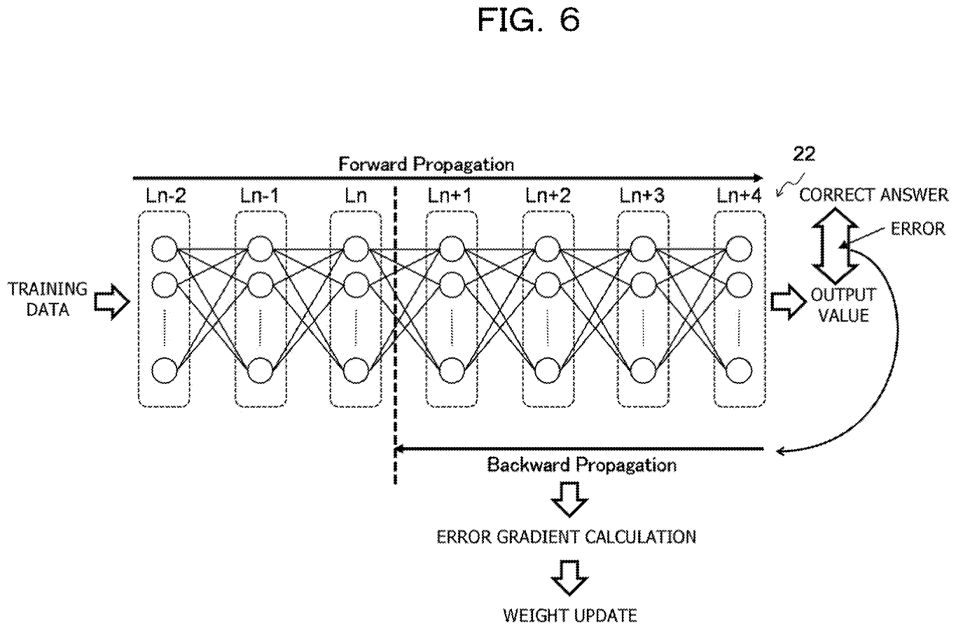

For example, in the example illustrated in FIG. 6, it is assumed that the skip setting unit 16 determines a third layer from a side of the input layer as the specific layer (Ln in FIG. 6). In this case, Ln−2, Ln−1, and Ln are the first layer group, and Ln+1, Ln+2, Ln+3, and Ln+4 are the second layer group. In this case, forward propagation is executed for all the layers and an error is calculated. In addition, the error is backward-propagated only up to Ln+1 by backward propagation. Thus, for each layer included in the second layer group, an error gradient is calculated and a weight is updated. On the other hand, for the first layer group, the error gradient calculation and the weight update are not executed.

With this configuration, as illustrated in FIG. 5, in each iteration, a calculation amount for the second processing and the third processing for each layer included in the first layer group is reduced. In addition, in one epoch, an accumulated amount of reduction in iterations after skipping is set is reduced.

As described above, in a case where setting is performed to skip a part of the learning processing in a part of the layers, prediction accuracy of the model reached at the end of the machine learning may deteriorate, or learning time may be increased to obtain desired prediction accuracy. For example, in a case where skipping is set at an appropriate timing and an appropriate layer is selected as a layer for setting skipping, the desired accuracy may be reached quickly. On the other hand, in a case where a timing for setting skipping and selection of a layer are not appropriate, the learning processing of layers after the layer for which skipping is set, for example, the second layer group may be influenced. In addition, in a case where a degree of the influence is large, there are problems that accuracy finally reached deteriorates and calculation time is increased.

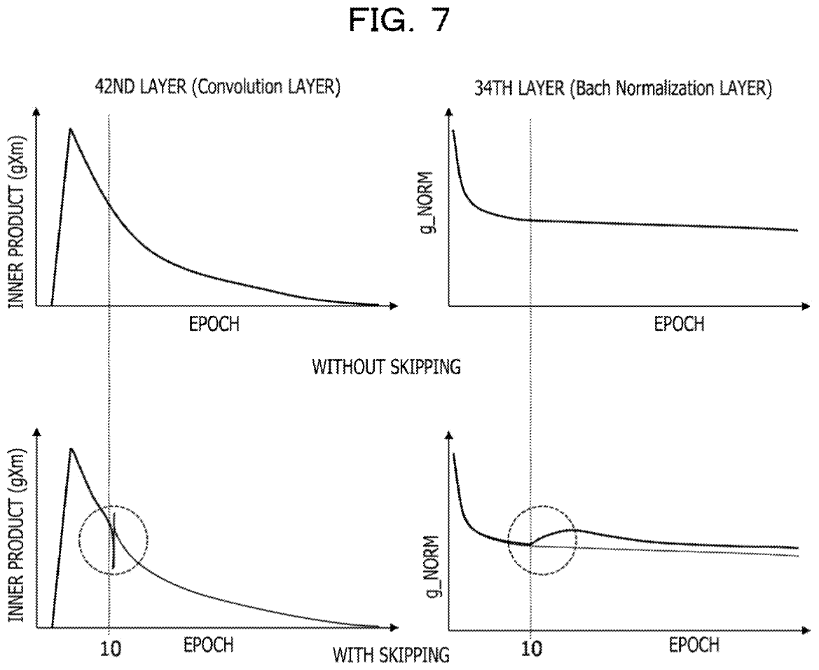

A more specific example will be described with reference to FIG. 7. FIG. 7 is a schematic diagram illustrating an evaluation value (details will be described later) for each epoch in a predetermined layer in a case where Residual Network (ResNet) 50 is used as the model 22. An upper part is a case where skipping is not set, and a lower part is a case where skipping is set from the input layer to a 33rd layer at a 10th epoch. Furthermore, in both the upper and lower parts, a left figure is an evaluation value for a 42nd layer (convolution layer), and a right figure is an evaluation value for a 34th layer (bach normalization layer). Note that, although the details will be described later, an example is indicated in which, for the 42nd layer, an inner product of the error gradient g and the momentum m (hereinafter referred to as “inner product (g×m)”) is used as the evaluation value, and for the 34th layer, an L2 norm of the error gradient g (hereinafter referred to as “g_norm”) is used as the evaluation value.

As illustrated in FIG. 7, in both the 34th layer immediately after the 33rd layer in which skipping is set and the 42nd layer away from the 33rd layer, there is a large fluctuation in the evaluation value immediately after the 10th epoch in which skipping is set. In a case where a change amount in the evaluation value is large in this way, accuracy finally reached may deteriorate or calculation time may be increased as compared with a case where skipping is not set.

Thus, the restart setting unit 18 determines, in a case where a part of the learning processing of each layer included in the first layer group is skipped, whether or not a change amount of an evaluation value of any of the layers included in the second layer group exceeds a predetermined threshold range. Then, in a case where the change amount of the evaluation value of any of the layers exceeds the predetermined threshold range, the restart setting unit 18 restarts the part of the learning processing skipped in each layer included in the first layer group.

For example, the restart setting unit 18 calculates an evaluation value for each layer for each iteration on the basis of information stored in the evaluation value DB 26. The evaluation value is a value by which accuracy finally reached of the machine-learned model 22 and learning time needed to obtain desired accuracy may be estimated. For example, the restart setting unit 18 may use the weight w, the error gradient g, and the momentum m as evaluation values as they are, or use at least one of the weight w, the error gradient g, and the momentum m to calculate an evaluation value. For example, the restart setting unit 18 may calculate the inner product (g×m), the g_norm, and the like as evaluation values.

Furthermore, the restart setting unit 18 calculates a change amount of the evaluation value with progress of the learning processing. For example, the restart setting unit 18 calculates a change amount between a statistical value of evaluation values calculated for a predetermined number of iterations in a first period including a current iteration, and a statistical value of evaluation values calculated for a predetermined number of iterations in a second period before the first period. For example, the restart setting unit 18 calculates the change amount of the evaluation value for each layer for every predetermined number of iterations. The predetermined number of times may be, for example, 100 iterations, the number of iterations for one epoch, or the like. Note that, in a case where the predetermined number of times is set to 1, the restart setting unit 18 calculates a change amount between an evaluation value for a current iteration and an evaluation value for a preceding iteration. Furthermore, the statistical value is an average, a maximum value, a minimum value, a median value, or the like. Hereinafter, a case where the average is used as the statistical value will be described.

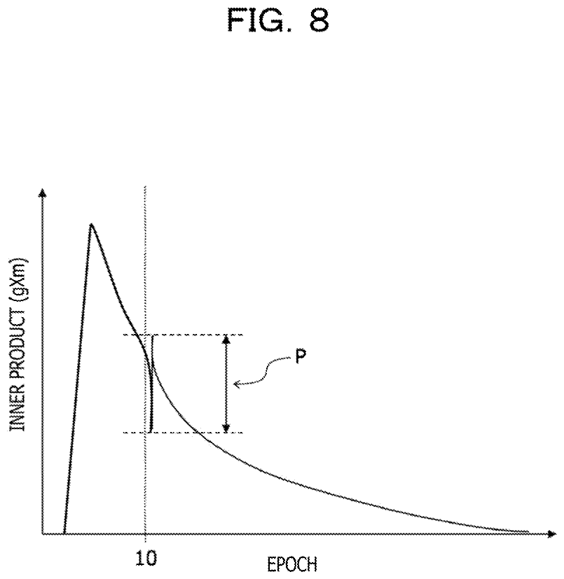

With reference to FIG. 8, a case will be described where skipping is set at the 10th epoch and the inner product (g×m) is used as the evaluation value to calculate the change amount of the evaluation value for each epoch. For example, the restart setting unit 18 calculates, at the end of each epoch, an average evaluation value obtained by averaging evaluation values calculated for iterations included in the epoch. Then, for example, the restart setting unit 18 calculates, as the change amount of the evaluation value, a difference between an average evaluation value calculated at an n-th (for example, 12th) epoch and an average evaluation value calculated at an (n−1)-th (for example, 11th) epoch. A part indicated by P in FIG. 8 corresponds to the change amount of the evaluation value for the n-th epoch. In a case where the change amount of the evaluation value calculated as described above exceeds a predetermined threshold range in any of the layers, the restart setting unit 18 cancels the skip setting and performs setting to restart the learning processing of the first layer group. For example, the restart setting unit 18 cancels the skip setting by lowering the flag which is set by the skip setting unit 16 and indicates that a part of the learning processing is skipped.

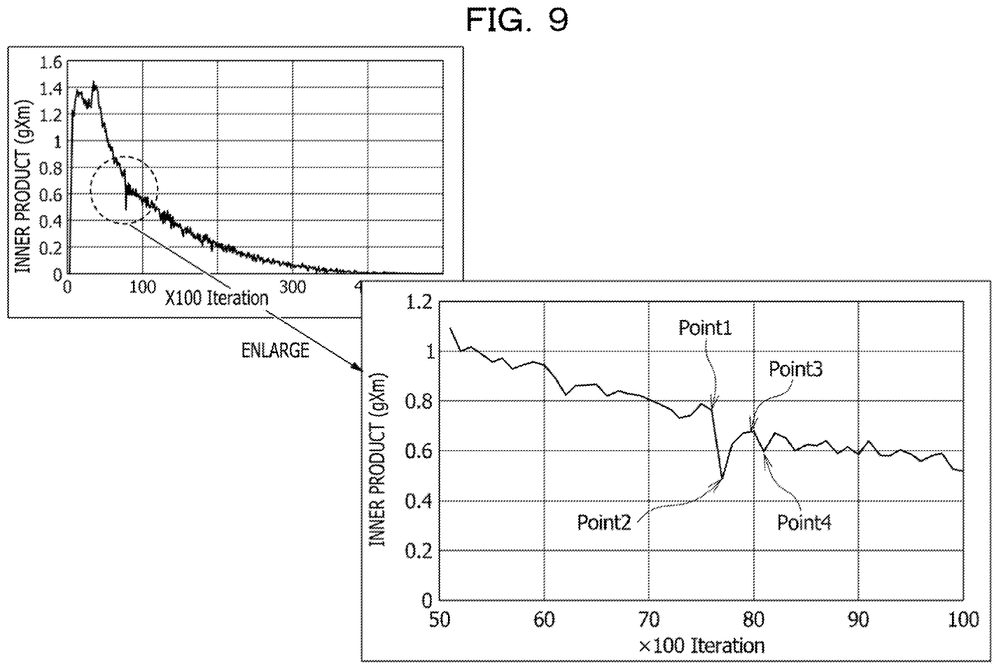

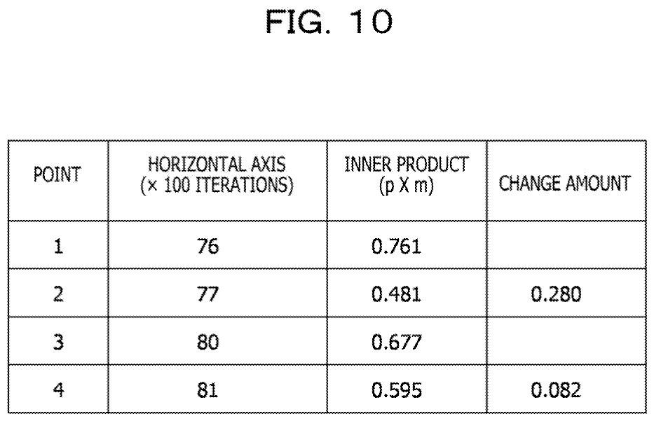

Here, an appropriate setting method of the threshold range to be compared with the change amount of the evaluation value will be described by indicating an example using a specific value. With reference to FIG. 9, a case will be described where the inner product (g×m) is used as the evaluation value to calculate the change amount of the evaluation value for every 100 iterations. For example, the inner product (g×m) indicated in FIG. 9 is a value obtained by averaging the inner products (g×m) for 100 iterations. A lower figure of FIG. 9 is a partially enlarged view including a part indicated by a circle of a broken line in an upper figure of FIG. 9. FIG. 10 indicates an evaluation value and a change amount of the evaluation value at each of Points 1 to 4 indicated in FIG. 9. For example, it is assumed that a change in the inner product (g×m) from the Point 1 to the Point 2 has an influence such as a deterioration in accuracy and an increase in learning time of the subsequent learning processing. On the other hand, it is assumed that a change in the inner product (g×m) from the Point 3 to the Point 4 does not have such an influence. In this case, it is desirable that the change amount of the evaluation value is determined to exceed the threshold range in the case of the Point 2, and that the change amount of the evaluation value is determined to be within the threshold range in the case of the Point 4. Thus, the threshold range may be set to, for example, a value of 0.15 to 0.2.

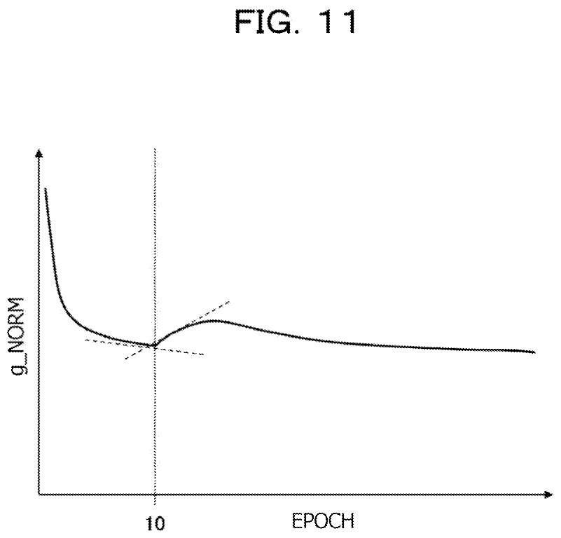

With reference to FIG. 11, another method of determining whether or not the change amount of the evaluation value exceeds the threshold range will be described. In the example of FIG. 11, a case will be described where skipping is set at the 10th epoch and the g_norm is used as the evaluation value to determine whether or not the change amount of the evaluation value exceeds the threshold range for each epoch. For example, in a case where a sign of a derivative of the average evaluation value calculated at the n-th epoch is inverted from a sign of a derivative of the average evaluation value calculated at the (n−1)-th epoch, the restart setting unit 18 may determine that the change amount of the evaluation value exceeds the threshold range. The example of FIG. 11 represents that a sign of a derivative of an average evaluation value of the 10th epoch is minus, and a sign of a derivative of an average evaluation value of an 11th epoch is plus. In this case, the restart setting unit 18 determines that the change amount of the evaluation value exceeds the threshold range at the 11th epoch.

Furthermore, the restart setting unit 18 may calculate a plurality of types of evaluation values for each layer, determine, for each evaluation value, whether or not the change amount of the evaluation value exceeds the threshold range, and in a case where the change amount of at least one type of the evaluation values exceeds the threshold, set restarting of the learning processing. Note that the inner product (g×m) is useful as the evaluation value in the present embodiment because the inner product (g×m) simply decreases as learning progresses in a case where there is no problem in the learning processing, and is an index by which the change amount in a case where a problem occurs in the learning processing is easy to grasp.

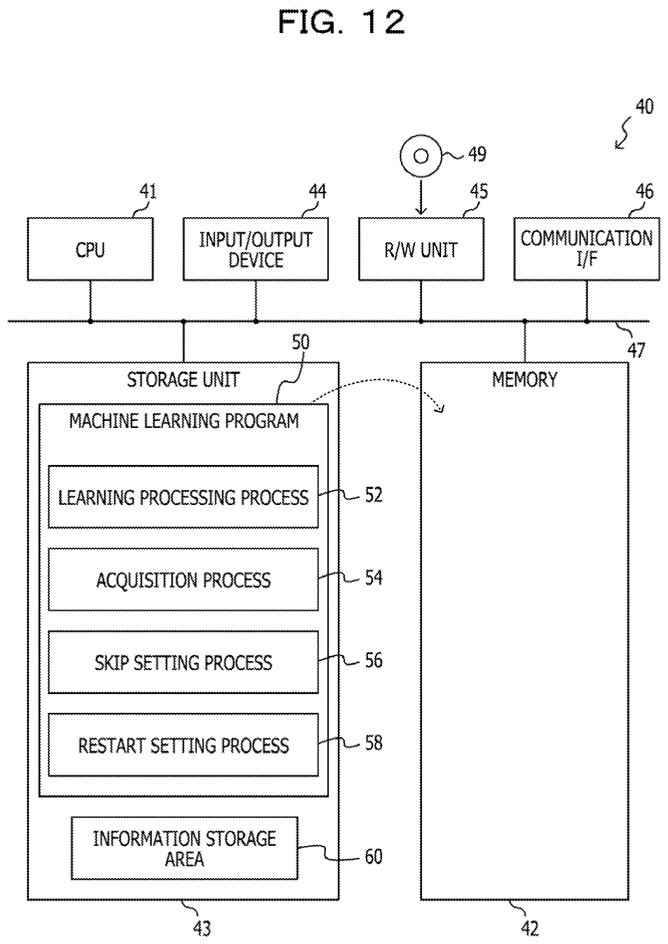

The machine learning apparatus 10 may be implemented by a computer 40 illustrated in FIG. 12, for example. The computer 40 includes a central processing unit (CPU) 41, a memory 42 as a temporary storage area, and a non-volatile storage unit 43. Furthermore, the computer 40 includes an input/output device 44 such as an input unit and a display unit, and a read/write (R/W) unit 45 that controls reading and writing of data from and to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are connected to each other via a bus 47.

The storage unit 43 may be implemented by a hard disk drive (HDD), a solid state drive (SSD), a flash memory, or the like. The storage unit 43 as a storage medium stores a machine learning program 50 for causing the computer 40 to function as the machine learning apparatus 10. The machine learning program 50 includes a learning processing process 52, an acquisition process 54, a skip setting process 56, and a restart setting process 58. Furthermore, the storage unit 43 includes an information storage area 60 for storing information constituting each of the training data DB 24, the model 22, and the evaluation value DB 26.

The CPU 41 reads out the machine learning program 50 from the storage unit 43, expands the machine learning program 50 in the memory 42, and sequentially executes the processes included in the machine learning program 50. The CPU 41 executes the learning processing process 52 to operate as the learning processing unit 12 illustrated in FIG. 1. Furthermore, the CPU 41 executes the acquisition process 54 to operate as the acquisition unit 14 illustrated in FIG. 1. Furthermore, the CPU 41 executes the skip setting process 56 to operate as the skip setting unit 16 illustrated in FIG. 1. Furthermore, the CPU 41 executes the restart setting process 58 to operate as the restart setting unit 18 illustrated in FIG. 1. Furthermore, the CPU 41 reads out information from the information storage area 60, and expands each of the training data DB 24, the model 22, and the evaluation value DB 26 in the memory 42. With this configuration, the computer 40 that has executed the machine learning program 50 functions as the machine learning apparatus 10. Note that the CPU 41 that executes the program is hardware.

Note that, functions implemented by the machine learning program 50 may also be implemented by, for example, a semiconductor integrated circuit, which is, in more detail, an application specific integrated circuit (ASIC) or the like.

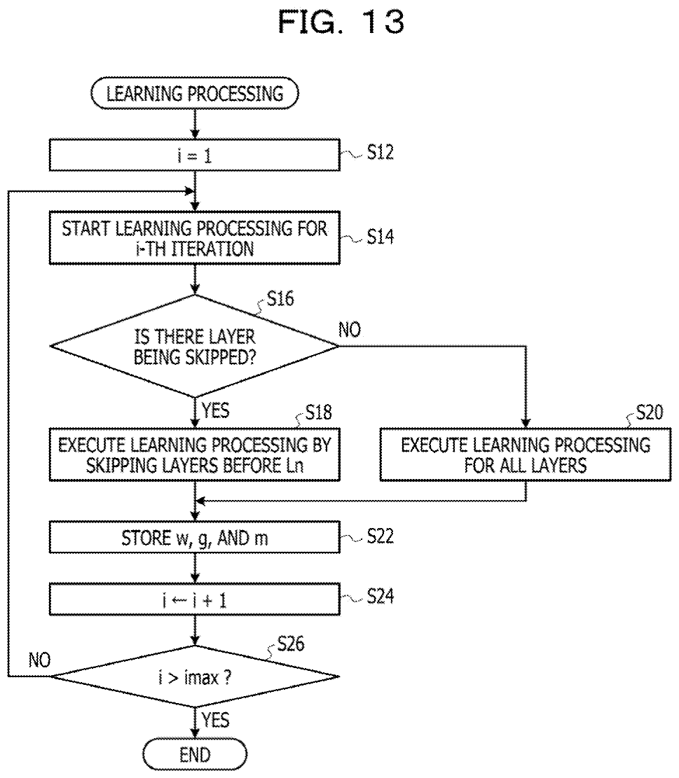

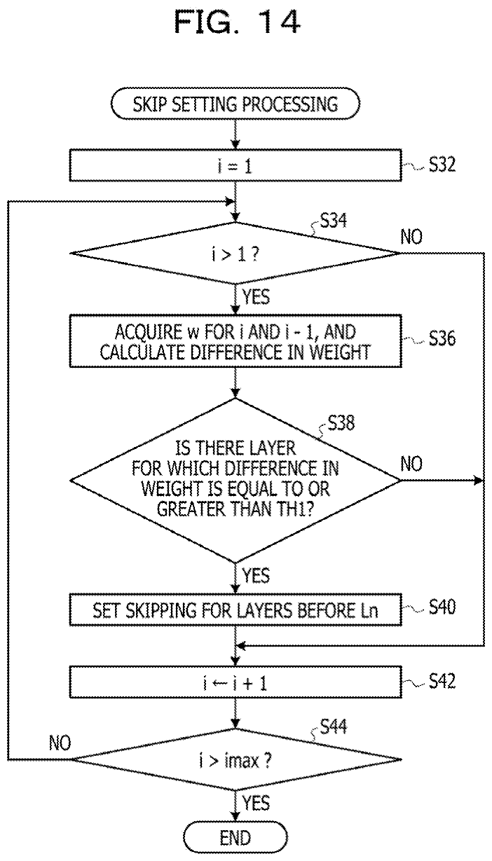

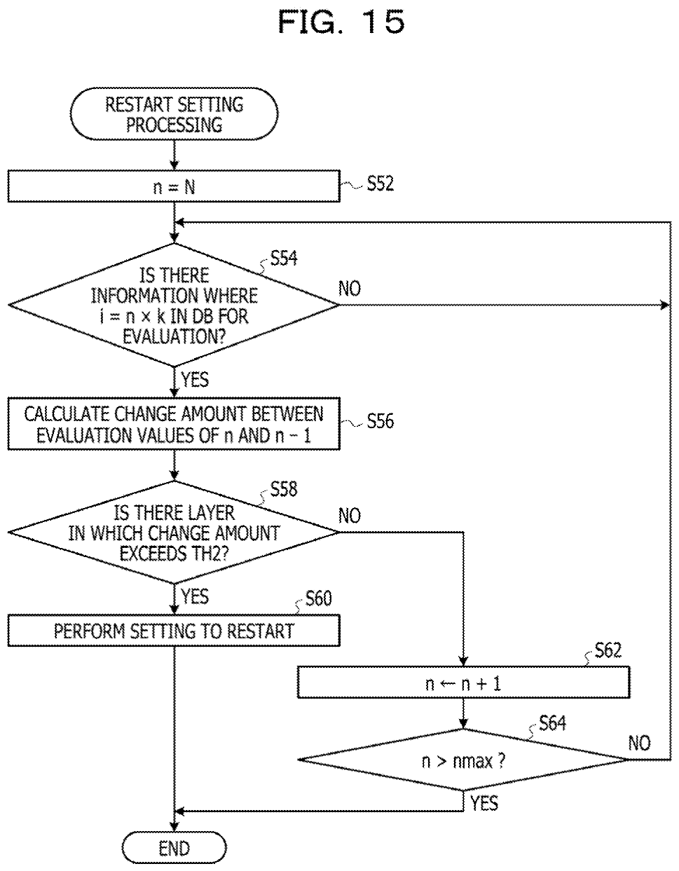

Next, operation of the machine learning apparatus 10 according to the present embodiment will be described. When machine learning of the model 22 is instructed, the machine learning apparatus 10 executes learning processing illustrated in FIG. 13 and skip setting processing illustrated in FIG. 14. Furthermore, when skipping is set for any of layers, the machine learning apparatus 10 executes restart setting processing illustrated in FIG. 15. Note that the learning processing, the skip setting processing, and the restart setting processing are examples of a machine learning method of the disclosed technology. Hereinafter, each of the learning processing, the skip setting processing, and the restart setting processing will be described in detail.

First, the learning processing illustrated in FIG. 13 will be described.

In Step S12, the learning processing unit 12 sets a variable i indicating the number of iterations to 1. Next, in Step S14, the learning processing unit 12 starts the learning processing for an i-th iteration.

Next, in Step S16, the learning processing unit 12 determines whether or not there is a layer for which skipping is set among layers included in the model 22. In a case where there is a layer for which skipping is set, the processing proceeds to Step S18, and in a case where skipping is not set for any layer, the processing proceeds to Step S20. In Step S18, the learning processing unit 12 executes the learning processing by skipping the second processing and the third processing for the first layer group (in the example of FIG. 6, the layers from Ln, which are on the side closer to the input) for which skipping is set. For example, for the first layer group, error calculation processing by forward propagation is executed, and error gradient calculation processing by backward propagation and weight update are skipped. Furthermore, all the types of the learning processing are executed for the second layer group (in the example of FIG. 6, the layers from Ln+1, which are on the side closer to the output), while in Step S20, the learning processing unit 12 executes all the types of the learning processing for all the layers.

Next, in Step S22, the acquisition unit 14 acquires a weight w, error gradient g, and momentum m of each layer obtained in the processing process of Step S18 or S20 described above, and stores the acquired weight w, error gradient g, and momentum m in the evaluation value DB 26.

Next, in Step S24, the learning processing unit 12 increments i by 1. Next, in Step S26, the learning processing unit 12 determines whether or not i exceeds an upper limit value imax of the number of iterations. In the case of i≤imax, the processing returns to Step S14, and in the case of i>imax, the learning processing ends.

Next, the skip setting processing illustrated in FIG. 14 will be described.

In Step S32, the skip setting unit 16 sets a variable i indicating the number of iterations to 1. Next, in Step S34, the skip setting unit 16 determines whether or not i exceeds 1. In the case of i>1, the processing proceeds to Step S36, and in the case of i≤1, the processing proceeds to Step S42.

In Step S36, the skip setting unit 16 acquires weights w for an i-th iteration and an (i−1)-th iteration for each layer from the evaluation value DB 26, and calculates a difference in weight as an index indicating progress of learning.

Next, in Step S38, the skip setting unit 16 determines whether or not there is a layer for which the difference in weight calculated in Step S36 described above is equal to or greater than a threshold TH1. In a case where there is a layer for which the difference in weight is equal to or greater than the threshold TH1, the processing proceeds to Step S40, and in a case where there is not such a layer, the processing proceeds to Step S42. In Step S40, the skip setting unit 16 determines a layer closest to a side of an output layer as a specific layer Ln, among layers that are continuous in order from an input layer, in each of which the calculated difference in weight is equal to or smaller than the threshold TH1. Then, the skip setting unit 16 performs setting to skip a part of the learning processing for each layer included in the first layer group from the input layer to the specific layer.

Next, in Step S42, the skip setting unit 16 increments i by 1. Next, in Step S44, the skip setting unit 16 determines whether or not i exceeds an upper limit value imax of the number of iterations. In the case of i≤imax, the processing returns to Step S34, and in the case of i>imax, the skip setting processing ends.

Next, the restart setting processing illustrated in FIG. 15 will be described.

In Step S52, the restart setting unit 18 sets a variable n indicating a point for determining whether or not a change amount of an evaluation value exceeds a threshold range TH2 to N. This point is set for every predetermined number of times k (k is, for example, 100 times, the number of iterations for one epoch, or the like) of iterations. N is the number of points that have ended when skipping is set. For example, in a case where determination is made every 100 iterations and skipping is set at a 500th iteration, k=100 and N=5.

Next, in Step S54, the restart setting unit 18 determines whether or not a weight w, an error gradient g, and a momentum m for an i-th iteration, where i=n×k, are stored in the evaluation value DB 26. For example, the restart setting unit 18 determines whether or not the weight w, the error gradient g, and the momentum m are stored for k iterations for which an average evaluation value at an n-th point may be calculated. In the case where each piece of the information is stored in the evaluation value DB 26, the processing proceeds to Step S56, and in a case where the information is not stored, the determination in this step is repeated.

In Step S56, the restart setting unit 18 calculates an evaluation value for each iteration from an ((n−1)×k)-th iteration to an (n×k)-th iteration, and calculates an average evaluation value obtained by averaging the calculated evaluation values as an evaluation value at the n-th point. Then, the restart setting unit 18 calculates a difference between the evaluation value calculated at the n-th point and an evaluation value calculated at an (n−1)-th point as the change amount of the evaluation value.

Next, in Step S58, the restart setting unit 18 determines whether or not the change amount of the evaluation value calculated in Step S56 described above exceeds the predetermined threshold range TH2. In a case where the change amount of the evaluation value exceeds the threshold range TH2, the processing proceeds to Step S60, and in a case where the change amount of the evaluation value is within the threshold range TH2, the processing proceeds to Step S62. In Step S60, the restart setting unit 18 cancels the skip setting and perform setting to restart the learning processing of the first layer group.

In Step S62, the restart setting unit 18 increments n by 1. Next, in Step S64, the restart setting unit 18 determines whether or not n exceeds an upper limit value nmax (nmax=imax/k) of the point. In the case of n≤nmax, the processing returns to Step S54, and in the case of n>nmax, the restart setting processing ends.

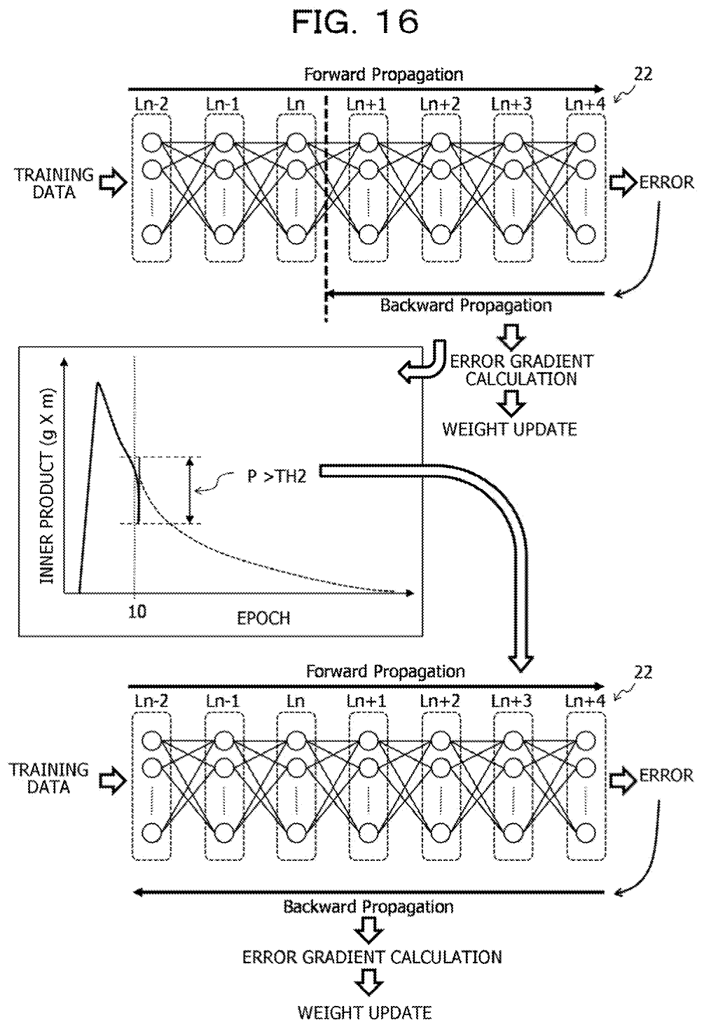

As illustrated in FIG. 16, in a case where a part of the learning processing is skipped in the first layer group of the model 22, by execution of the restart setting processing described above, it is determined whether or not a change amount P of an evaluation value exceeds the threshold range TH2 in any layer of the second layer group. Then, in the case of P>TH2, the part of the learning processing skipped in the first layer group is restarted.

As described above, the machine learning apparatus according to the present embodiment acquires, in deep learning of a model including a plurality of layers including an input layer and an output layer, information indicating a learning status such as a weight, an error gradient, and a momentum, for example, for each iterative processing of learning processing. Furthermore, the machine learning apparatus determines progress of learning of each layer on the basis of the information indicating the learning status, and performs setting to skip a part of learning processing of each layer which is included in a first layer group from the input layer to a specific layer and in which the progress of the learning satisfies a predetermined condition. For example, error gradient calculation by backward propagation and weight update are skipped. Then, in a case where the part of the learning processing of each layer included in the first layer group is skipped, the learning processing unit determines whether or not a change amount of an evaluation value of any of layers included in a second layer group from the next layer of the specific layer, which is close to a side of the output layer, to the output layer exceeds a predetermined threshold range. The evaluation value is calculated on the basis of the information indicating the learning status. In a case where the change amount of the evaluation value exceeds the predetermined threshold range, the machine learning apparatus restarts the part of the learning processing skipped in each layer included in the first layer group.

In this way, the machine learning apparatus according to the present embodiment determines, on the basis of the change amount of the evaluation value, whether or not a status occurs that results in a deterioration in prediction accuracy or an increase in learning time in the learning processing of the layers closer to the side of the output than the layers for which skipping is set. With this configuration, the machine learning apparatus according to the present embodiment may avoid inappropriate skipping of learning processing that results in a deterioration in prediction accuracy and an increase in learning time.

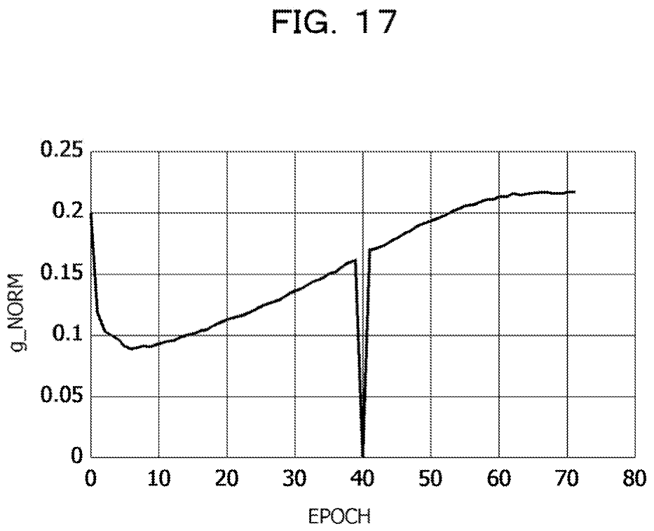

Here, a result of comparing accuracy evaluations between the method in the present embodiment (hereinafter referred to as “this method”) and two comparative examples will be described. A first comparative example is a method in which skipping is not set (hereinafter referred to as “no skipping”), and a second comparative example is a method in which skipping is set but restarting is not set (hereinafter referred to as “no restarting”). In each of the methods, the ResNet50 was used as a model, and a change amount of an evaluation value was determined for each epoch. Furthermore, for this method and no restarting, skipping was set for each layer up to the 33rd layer at a 40th epoch. Furthermore, in this method, the learning processing was restarted after one epoch at which skipping was set. FIG. 17 illustrates a g_norm for each epoch for this method.

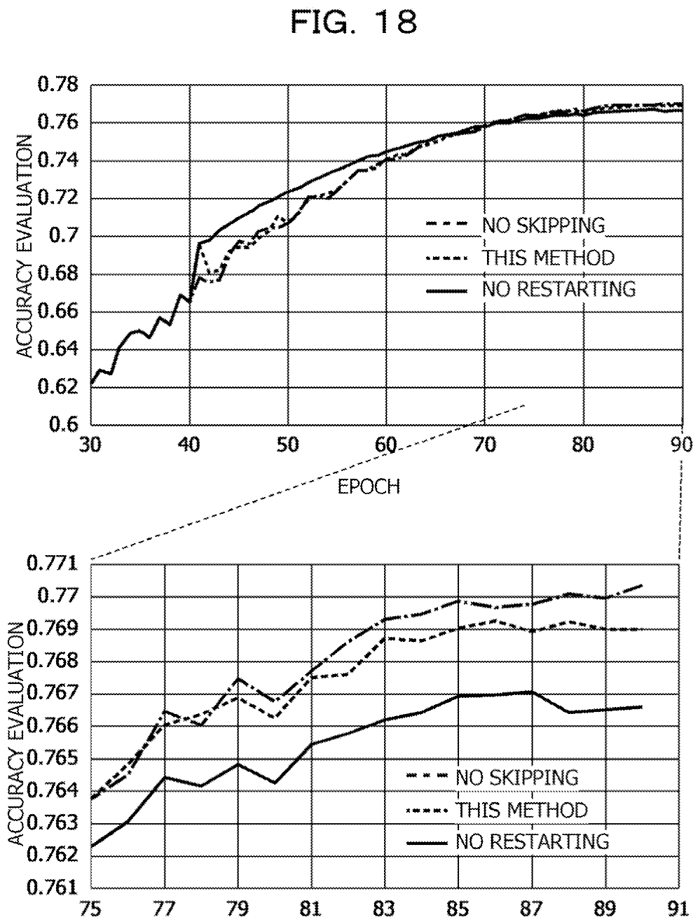

As illustrated in FIG. 18, an accuracy evaluation of this method (broken line) greatly exceeds that of the case of no restarting (solid line), even if it does not reach that of the case of no skipping (alternate long and short dash line). This represents that this method was able to avoid inappropriate skipping.

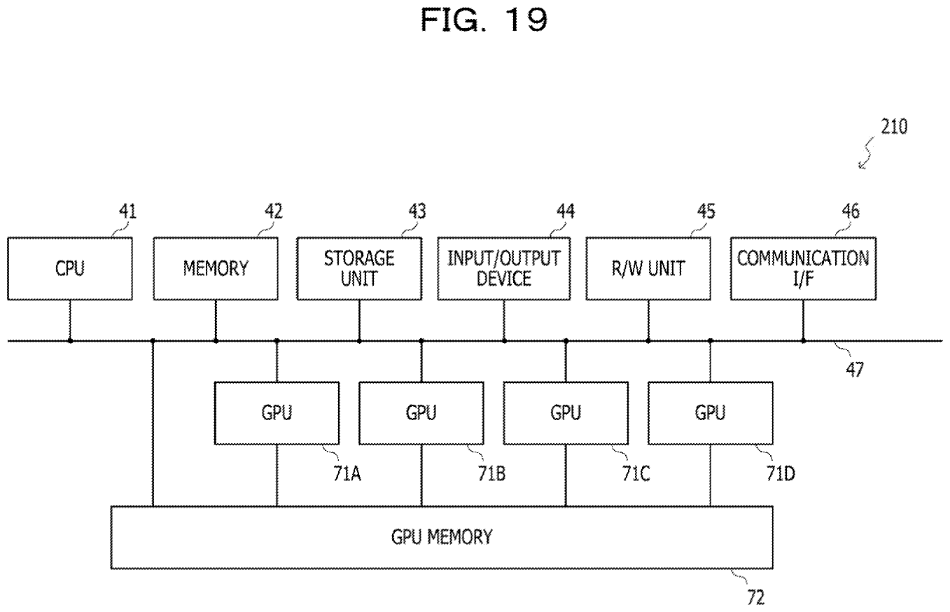

Note that, in the embodiment described above, the learning processing may be processed by a plurality of arithmetic units. In this case, the machine learning apparatus may be implemented by a computer 210 having a hardware configuration as illustrated in FIG. 19. The computer 210 includes a plurality of (four in the example of FIG. 19) graphics processing units (GPUs) 71A, 71B, 71C, and 71D, and a GPU memory 72, in addition to the CPU 41, the memory 42, the storage unit 43, the input/output device 44, the R/W unit 45, and the communication I/F 46. The components described above are connected to each other via the bus 47. Hereinafter, in a case where the GPUs 71A, 71B, 71C, and 71D are described without any distinction, these GPUs are simply referred to as “GPUs 71”.

In this case, the CPU 41 stores the model 22 in the GPU memory 72 and inputs a different piece of training data to each of the GPUs 71. By using the input training data, each of the GPUs 71 executes the first processing (error calculation by forward propagation) and the second processing (error gradient calculation by backward propagation). Then, the error gradients calculated by the GPUs 71 are integrated by, for example, performing communication between the GPUs 71 by AllReduce or the like, and a common error gradient used by each of the GPUs 71 to execute the third processing (weight update) is calculated.

With this configuration, it is possible to reduce a calculation amount related to the error gradient calculation and the weight update in each of the GPUs 71 for each layer included in the first layer group for which the learning processing is skipped. Furthermore, it is possible to reduce a communication amount between the GPUs 71 for integrating the error gradients calculated by the GPUs 71.

Furthermore, while a mode in which the machine learning program is stored (installed) in the storage unit in advance has been described in the embodiment described above, the disclosed technology is not limited thereto. The program according to the disclosed technology may also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute processing comprising:
acquiring, in deep learning of a model that includes a plurality of layers that includes an input layer and an output layer, information that indicates a learning status for each iterative processing of learning processing;
determining progress of learning of each layer on the basis of the information that indicates the learning status;
skipping a part of learning processing of each layer which is included in a first layer group from the input layer to a specific layer and in which the progress of the learning satisfies a predetermined condition; and
restarting the part of the learning processing skipped in each layer included in the first layer group in a case where the part of the learning processing of each layer included in the first layer group is skipped and a change amount of an evaluation value, which is based on the information that indicates the learning status, of any of layers included in a second layer group from a next layer of the specific layer, which is close to a side of the output layer, to the output layer exceeds a predetermined threshold range.

2. The non-transitory computer-readable recording medium storing the machine learning program according to claim 1, wherein
the learning processing includes first processing of calculating an error between an output value output from the output layer by inputting training data from the input layer and a correct answer to the training data, second processing of backward-propagating information regarding the error from the output layer to the input layer and calculating an error gradient for a weight between layers, and third processing of updating the weight between the layers by using the calculated error gradient, and
in a case where the part of the learning processing is skipped, the second processing and the third processing are skipped.

3. The non-transitory computer-readable recording medium storing the machine learning program according to claim 2, wherein, in a case where the learning processing is processed by a plurality of arithmetic units, the error gradients calculated by executing the first processing and the second processing by using a different type of training data in each of the plurality of arithmetic units are integrated to obtain an error gradient used in the third processing.

4. The non-transitory computer-readable recording medium storing the machine learning program according to claim 1, wherein the evaluation value is a value represented by using a weight between layers, an error gradient, or a momentum or any combination of the weight between layers, the error gradient, or the momentum.

5. The non-transitory computer-readable recording medium storing the machine learning program according to claim 4, wherein an inner product of the error gradient and the momentum is used as the evaluation value.

6. The non-transitory computer-readable recording medium storing the machine learning program according to claim 1, wherein
the processing of acquiring the information that indicates the learning status includes acquiring the information that indicates the learning status for every one iteration, which is a minimum unit of iterative processing of the learning, and
the change amount of the evaluation value is a change amount between an evaluation value based on the information that indicates the learning status acquired in a current iteration and an evaluation value based on the information that indicates the learning status acquired in a preceding iteration, or a change amount between a statistical value of evaluation values based on the information that indicates the learning status, which are acquired in a predetermined number of iterations in a first period that includes the current iteration, and a statistical value of evaluation values based on the information that indicates the learning status, which are acquired in a predetermined number of iterations in a second period before the first period.

7. A information processing apparatus comprising:
a memory; and
a processor coupled to the memory and configured to:
acquire, in deep learning of a model that includes a plurality of layers that includes an input layer and an output layer, information that indicates a learning status for each iterative processing of learning processing;
determine progress of learning of each layer on the basis of the information that indicates the learning status;
skip a part of learning processing of each layer which is included in a first layer group from the input layer to a specific layer and in which the progress of the learning satisfies a predetermined condition; and
restart the part of the learning processing skipped in each layer included in the first layer group in a case where the part of the learning processing of each layer included in the first layer group is skipped and a change amount of an evaluation value, which is based on the information that indicates the learning status, of any of layers included in a second layer group from a next layer of the specific layer, which is close to a side of the output layer, to the output layer exceeds a predetermined threshold range.

8. The information processing apparatus according to claim 7, wherein
the learning processing includes first processing of calculating an error between an output value output from the output layer by inputting training data from the input layer and a correct answer to the training data, second processing of backward-propagating information regarding the error from the output layer to the input layer and calculating an error gradient for a weight between layers, and third processing of updating the weight between the layers by using the calculated error gradient, and
in a case where the part of the learning processing is skipped, the second processing and the third processing are skipped.

9. The information processing apparatus according to claim 8, wherein, in a case where the learning processing is processed by a plurality of arithmetic units, the error gradients calculated by executing the first processing and the second processing by using a different type of training data in each of the plurality of arithmetic units are integrated to obtain an error gradient used in the third processing.

10. The information processing apparatus according to claim 7, wherein the evaluation value is a value represented by using a weight between layers, an error gradient, or a momentum or any combination of the weight between layers, the error gradient, or the momentum.

11. The information processing apparatus according to claim 10, wherein an inner product of the error gradient and the momentum is used as the evaluation value.

12. The information processing apparatus according to claim 7, wherein
the processing of acquiring the information that indicates the learning status includes acquiring the information that indicates the learning status for every one iteration, which is a minimum unit of iterative processing of the learning, and
the change amount of the evaluation value is a change amount between an evaluation value based on the information that indicates the learning status acquired in a current iteration and an evaluation value based on the information that indicates the learning status acquired in a preceding iteration, or a change amount between a statistical value of evaluation values based on the information that indicates the learning status, which are acquired in a predetermined number of iterations in a first period that includes the current iteration, and a statistical value of evaluation values based on the information that indicates the learning status, which are acquired in a predetermined number of iterations in a second period before the first period.

13. A machine learning method comprising:
acquiring, by a computer, in deep learning of a model that includes a plurality of layers that includes an input layer and an output layer, information that indicates a learning status for each iterative processing of learning processing;
determining progress of learning of each layer on the basis of the information that indicates the learning status;
skipping a part of learning processing of each layer which is included in a first layer group from the input layer to a specific layer and in which the progress of the learning satisfies a predetermined condition; and
restarting the part of the learning processing skipped in each layer included in the first layer group in a case where the part of the learning processing of each layer included in the first layer group is skipped and a change amount of an evaluation value, which is based on the information that indicates the learning status, of any of layers included in a second layer group from a next layer of the specific layer, which is close to a side of the output layer, to the output layer exceeds a predetermined threshold range.

14. The machine learning method according to claim 13, wherein
the learning processing includes first processing of calculating an error between an output value output from the output layer by inputting training data from the input layer and a correct answer to the training data, second processing of backward-propagating information regarding the error from the output layer to the input layer and calculating an error gradient for a weight between layers, and third processing of updating the weight between the layers by using the calculated error gradient, and
in a case where the part of the learning processing is skipped, the second processing and the third processing are skipped.

15. The machine learning method according to claim 14, wherein, in a case where the learning processing is processed by a plurality of arithmetic units, the error gradients calculated by executing the first processing and the second processing by using a different type of training data in each of the plurality of arithmetic units are integrated to obtain an error gradient used in the third processing.

16. The machine learning method according to claim 13, wherein the evaluation value is a value represented by using a weight between layers, an error gradient, or a momentum or any combination of the weight between layers, the error gradient, or the momentum.

17. The machine learning method according to claim 16, wherein an inner product of the error gradient and the momentum is used as the evaluation value.

18. The machine learning method according to claim 13, wherein
the processing of acquiring the information that indicates the learning status includes acquiring the information that indicates the learning status for every one iteration, which is a minimum unit of iterative processing of the learning, and
the change amount of the evaluation value is a change amount between an evaluation value based on the information that indicates the learning status acquired in a current iteration and an evaluation value based on the information that indicates the learning status acquired in a preceding iteration, or a change amount between a statistical value of evaluation values based on the information that indicates the learning status, which are acquired in a predetermined number of iterations in a first period that includes the current iteration, and a statistical value of evaluation values based on the information that indicates the learning status, which are acquired in a predetermined number of iterations in a second period before the first period.
